(19) United States
(12) Patent Application Publication
(10) Pub. No.: US 2021/0279793 A1
(43) Pub. Date: Sep. 9, 2021

(54) SYSTEM AND METHOD FOR GENERATING AND UTILIZING A MASTER FINANCIAL ACCOUNT

(71) Applicant: STATE FARM MUTUAL AUTOMOBILE INSURANCE COMPANY, Bloomington, IL (US)

(72) Inventors: William J. Leise, Normal, IL (US); Douglas Albert Graff, Mountain View, MO (US); Christina P. Mullen, Bloomington, IL (US)

(21) Appl. No.: 15/093,894

(22) Filed: Apr. 8, 2016

Related U.S. Application Data
(60) Provisional application No. 62/318,928, filed on Apr. 6, 2016.

(51) Int. Cl. G06Q 40/02; G06Q 40/06

(52) U.S. Cl. CPC G06Q 40/02; G06Q 40/06

(57) ABSTRACT

A computer-implemented method for providing a master financial account (MFA) may include receiving authorization from a user to link one or more accounts to the MFA. The linked accounts may be analyzed to determine one or more changes that may potentially benefit the user. A recommendation may be generated that includes one or more changes to be made to one or more accounts, based on the analysis. The recommendation and/or an indication of the potential benefits may be transmitted to the user. The transmission to the user may include a request to authorize implementation of one or more elements of the recommendation. If the user authorizes the implementation of one or more elements of the recommendation, the authorized changes to the accounts may be implemented.

### CROSS-REFERENCE TO RELATED APPLICATION

This claims the benefit of U.S. Provisional Patent Application No. 62/318,928, filed on Apr. 6, 2016 and entitled “System and Method for Generating and Utilizing a Master Financial Account,” the entire disclosure of which is hereby incorporated herein by reference.

### FIELD OF THE DISCLOSURE

The present disclosure generally relates to financial systems and, more specifically, to systems and methods for accessing, analyzing, and managing accounts.

### BACKGROUND

Increasingly, financial institutions and investment companies are providing means for customers to access and manage their accounts via the Internet. To access personal accounts that are provided and maintained by a particular financial institution, a customer typically visits a web site of that financial institution and uses web pages of the web site to view account balances and make changes to the accounts. For example, the customer might initiate deposits, withdrawals, and/or transfers of funds among that financial institution's accounts. The customer might also open or close accounts, change account profile information, pay bills, change deductions and/or contributions, apply for loans or mortgages, or add or remove authorization of automatic transactions among that financial institution's accounts. However, the customer typically has to individually log in to a fairly large number of different accounts and/or web sites in order to review and manage all of his or her account information, which can be cumbersome and time-consuming.

Further, customers often focus on managing individual accounts and miss the broader perspective of an overall financial management strategy. In addition, customers might get overwhelmed by the amount of information from the various accounts, and might not be able to objectively and quantitatively analyze the overall financial situation. Customers might therefore make decisions in a piecemeal fashion based on only a portion of their financial situation and, as a result, fail to achieve the optimum allocation of their financial assets. Some customers might not make fully informed decisions on transferring funds, saving the most appropriate amounts to achieve financial objectives, or paying down mortgages or other financial obligations, for example.

### BRIEF SUMMARY

The present embodiments may, inter alia, provide individuals with an improved user/customer experience, and/or improved financial results, by reducing the amount of time and/or effort that must be spent in order to manage accounts from among various financial institutions, and/or by identifying finance-related opportunities that might otherwise go unnoticed.

In one aspect, a computer-implemented method for providing a master financial account for a user may include receiving, by one or more processors and from the user, authorization to link a plurality of accounts of the user to the master financial account, at least some of the plurality of accounts being associated with different financial institutions, and in response to receiving the authorization, linking, by one or more processors, the plurality of accounts to the master financial account. Linking the plurality of accounts to the master financial account may include adding each of the plurality of accounts to a master financial account record. In addition, the method may include analyzing, by one or more processors, information in the plurality of accounts that are linked to the master financial account to determine changes that could be made to benefit the user. Analyzing the information in the plurality of accounts may include performing an analysis of information in at least a first account of the plurality of accounts to determine one or more changes that could be made to at least a second account of the plurality of accounts to benefit the user. Additionally, the method may include generating, by one or more processors, a recommendation for the one or more changes to at least the second account. The method may also include sending to the user, by one or more processors, both (i) the recommendation for the one or more changes to at least the second account, and (ii) an indication of one or more potential benefits of making the one or more changes. In addition, the method may include receiving, by one or more processors, an authorization from the user to adopt the recommendation for the one or more changes to at least the second account, and implementing, based on the authorization from the user, and by one or more processors, the recommendation for the one or more changes to at least the second account.

In another aspect, a tangible, non-transitory computer-readable medium stores instructions that may, when executed by one or more processors, cause the one or more processors to receive, from the user, authorization to link a plurality of accounts of the user to the master financial account, at least some of the plurality of accounts being associated with different financial institutions. In response to receiving the authorization, the instructions may cause the one or more processors to link the plurality of accounts to the master financial account, at least in part by adding each of the plurality of accounts to a master financial account record. The instructions may also cause the one or more processors to analyze information in the plurality of accounts that are linked to the master financial account to determine changes that could be made to benefit the user, at least in part by performing an analysis of information in at least a first account of the plurality of accounts to determine one or more changes that could be made to at least a second account of the plurality of accounts to benefit the user. Additionally, the instructions may cause the one or more processors, to generate a recommendation for the one or more changes to at least the second account. The instructions may also cause the one or more processors to send to the user both (i) the recommendation for the one or more changes to at least the second account, and (ii) an indication of one or more potential benefits of making the one or more changes. In addition, the instructions may cause the one or more processors to receive an authorization from the user to adopt the recommendation for the one or more changes to at least the second account, and to implement, based on the authorization from the user, the recommendation for the one or more changes to at least the second account.

In a third aspect, a server may include one or more processors, a communication module configured to transmit and receive data via one or more networks, and a non-transitory memory. The non-transitory memory may store instructions that, when executed by the one or more processors, may cause the one or more processors to receive from the user, authorization to link a plurality of accounts of a user to a master financial account, at least some of the plurality of accounts being associated with different financial institutions. In response to receiving the authorization, the instructions may cause the plurality of accounts to be linked to the master financial account, at least in part by adding each of the plurality of accounts to a master financial account record. The instructions may cause the information in the plurality of accounts that are linked to the master financial account to be analyzed to determine changes that could be made to benefit the user, at least in part by performing an analysis of information in at least a first account of the plurality of accounts to determine one or more changes that could be made to at least a second account of the plurality of accounts to benefit the user. Further, the instructions may cause a recommendation to be generated for the one or more changes to at least the second account and may cause a transmission to be sent to the user including both (i) the recommendation for the one or more changes to at least the second account, and (ii) an indication of one or more potential benefits of making the one or more changes. In response to receiving an authorization from the user to adopt the recommendation for the one or more changes to at least the second account, the instructions may cause the recommendation for the one or more changes to at least the second account to be implemented.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof.

FIG. 1 depicts an example environment including components associated with creating and managing a master financial account, according to an embodiment.

FIG. 2A is a sequence diagram depicting an example process in which a user links accounts to a master financial account, according to an embodiment.

FIG. 2B is a sequence diagram depicting an example process in which accounts are analyzed to provide one or more recommendations and an indication of the potential benefits to a user, according to an embodiment.

FIG. 2C is a sequence diagram depicting an example process in which one or more recommendations are authorized by the user and implemented, according to an embodiment.

FIG. 3A depicts an example interactive display provided by a master financial account software application and showing accounts linked to the master financial account, according to one embodiment.

FIG. 3B depicts an example interactive display provided by a master financial account software application and showing a recommendation and authorization screen, according to an embodiment.

FIG. 3C depicts an example interactive display provided by a master financial account software application and showing potential benefits of implementing the recommendation(s), according to an embodiment.

FIG. 3D depicts an example interactive display provided by a master financial account software application and showing a confirmation screen, according to an embodiment.

FIG. 4 is a flow diagram depicting an example method for generating and utilizing a master financial account, according to an embodiment.

FIG. 5 depicts an example client-side system, including an electronic device operated by the user, by which some of the techniques described herein may be implemented, according to an embodiment.

FIG. 6 depicts an example back-end computer system, including a master financial account server, by which some of the techniques described herein may be implemented, according to an embodiment.

### DETAILED DESCRIPTION

### I. Exemplary Master Financial Account

The present embodiments relate to the creation, management, and utilization of a single master financial account (also referred to herein as an “MFA”) to which accounts from multiple different financial institutions (e.g., banks, investment companies, etc.), and possibly other types of commercial or non-commercial institutions (e.g., utility companies, government agencies, etc.), may be linked. The MFA software may reduce the amount of time and/or effort that a customer (also referred to herein as a “user”) must spend in order to manage accounts from among the various institutions. Instead of logging in to one account after another, and/or logging in to the account web pages of multiple institutions, the user may log in to one MFA, initiate transactions, and complete transactions such as deposits, withdrawals, and transfers among accounts of the user that are associated with different institutions.

In some embodiments, the MFA may be provided by or through a financial institution (e.g., a bank, an investment company, a mortgage company, a financial planning organization, etc.), an insurance company, a utility company, a government institution, or another institution or organization capable of both (1) providing the software and (2) communicating remotely and electronically with the user and all of the other institutions providing accounts that the user may desire to link to the MFA. The link connections may be established via landlines, wireless communications systems, and/or other commercially available forms of communication for financial data. A user may gain access to the MFA via a desktop computer, laptop computer, tablet, phablet, smart phone, and/or any other electronic device capable of viewing account information and enabling user interaction (e.g., via a graphical user interface). The user may access and make changes to one or more of a plurality of linked accounts during a single login session via the MFA.

MFA software executing on a server may create, maintain, and/or modify the MFA. The MFA software may perform various different functions. For example, the MFA software may be configured to automatically pay utility bills on time for the user (i.e., the holder or owner of the MFA), perform automatic loan and/or mortgage payments for the user, and so on. Additionally, the MFA software may analyze information associated with some or all of the linked accounts. For example, the analysis software may analyze account balances, interest rates, payment amounts, changes to account information (e.g., changes to balances, rates and/or payment amounts, or changes in accounts such as a month-over-month decrease in electric bills or increase in natural gas bills, a credit card interest rate increase, etc.), and/or other types of account information. The analysis may also account for advertised or other promotional opportunities (e.g., bundling for telephone and/or internet services, a minimum savings account balance needed to achieve a higher interest rate, etc.).

Based on the analysis, the analysis software may identify one or more potential changes to the linked accounts that, if implemented, may benefit the user financially, and may recommend those changes to the user. For example, the analysis software may determine that there is an increase in the income of the user, based on a “step up” in the periodic deposits made by an employer into a linked account used to receive direct deposit paychecks. The MFA server may monitor the income increase for a predetermined period of time to determine if it is a temporary increase or a persistent increase. If it is determined to be persistent, the MFA software may generate a recommendation to use at least part of the increase to pay ahead on mortgage payments, and/or to use another part of the additional income to increase contributions to a college savings account, etc. As another example, if the analysis software determines that the user is paying more per month for a utility than at a similar time the previous year, the MFA software may generate a recommendation to investigate an annualized payment plan or another service provider.

More generally, various different types of recommendations may be generated, such as recommendations to deposit funds into one or more linked accounts, recommendations to withdrawal funds from one or more linked accounts, recommendations to transfer funds between two or more linked accounts, recommendations to close one or more linked accounts, recommendations to open a new account, recommendations to refinance a current mortgage, and so on. The MFA software may also determine/identify potential benefits of following the recommendation(s), such as a projection of increased retirement savings, an earlier retirement date, lower interest rate payments, etc. The recommendation(s) and/or potential benefit(s) may be transmitted to the user's electronic device, or to multiple electronic devices of the user. Alternatively, a notice that one or more recommendations and/or potential benefits is/are available may be transmitted to the user's electronic device(s) (e.g., with a link to a web site where the user may view the full details of the recommendation(s) and/or potential benefits). If potential benefits are transmitted to the user along with the recommendation(s), the benefits may be presented as a financial projection or summary (e.g., text and/or information in a graphical format such as a table, chart or graph), for example.

### II. Exemplary Environment for Creating and Managing a Master Financial Account

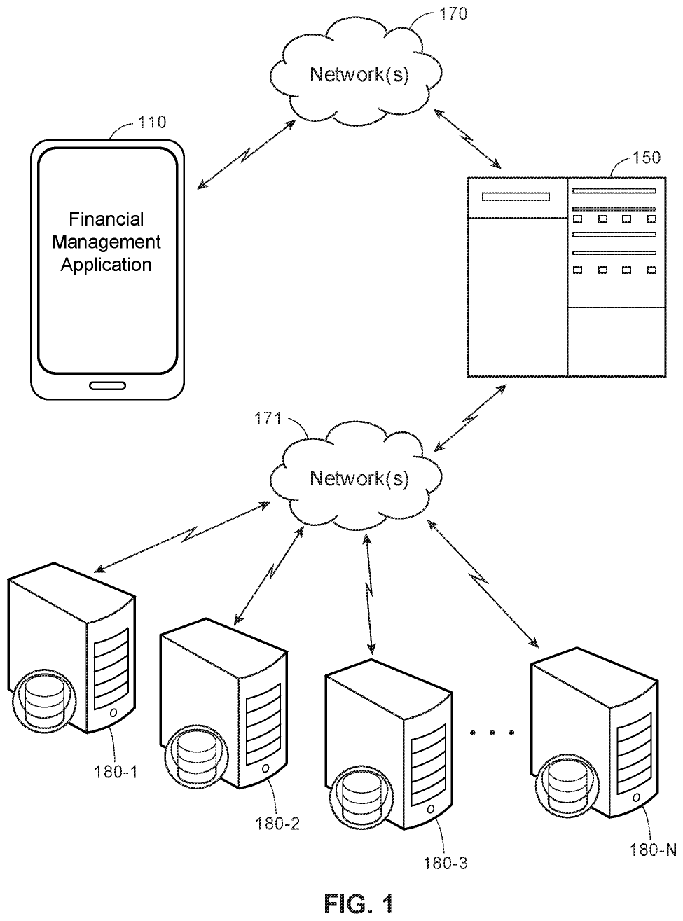

FIG. 1 depicts an example environment 100 including components associated with accessing an MFA, according to an embodiment. As illustrated in FIG. 1, the environment 100 may include one or more electronic device(s) 110 and a master financial account server (also referred to herein as an “MFA server”) 150. The electronic device 110 may be a personal computer (e.g., desktop, laptop, notebook, or tablet), a phablet, a smartphone, or another wired or wireless communication device. The electronic device(s) 110 may be communicatively coupled to the MFA server 150 via network(s) 170. The network(s) 170 may be a single communication network, or may include multiple communication networks of one or more types (e.g., one or more wired and/or wireless local area networks (LANs), and/or one or more wired and/or wireless wide area networks (WANs) such as the Internet).

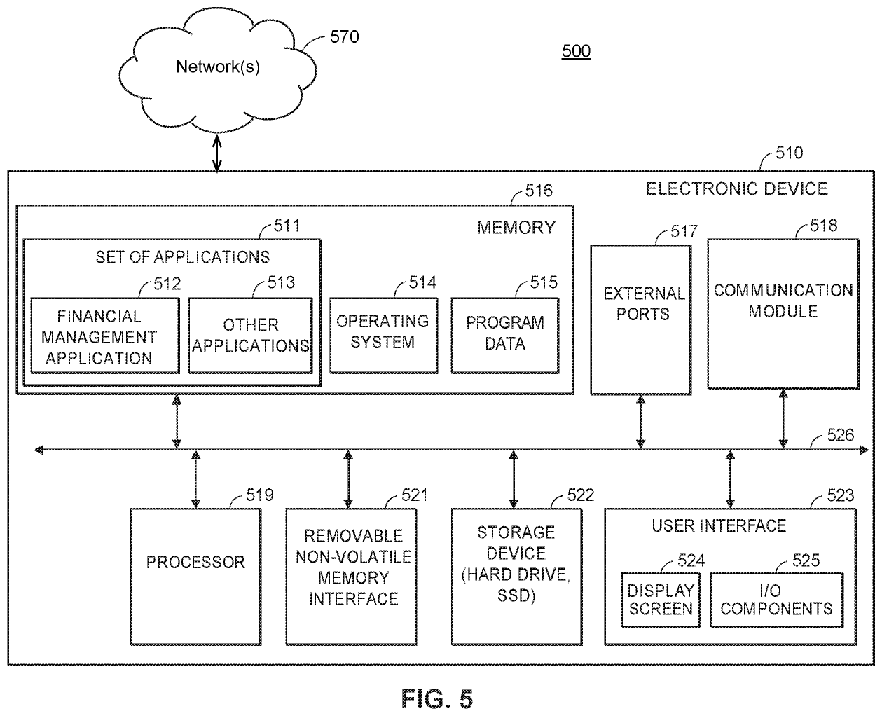

A financial management application (app) may be resident on the electronic device 110. For example, the financial management app may comprise a set of software instructions stored in a memory of the electronic device 110 and executing on one or more processors of the electronic device 110 (e.g., see FIG. 5 and the corresponding description below). The financial management app resident on the electronic device 110 may provide the user of the electronic device 110 with one or more user-interactive displays (e.g., graphical user interfaces or GUIs) that enable the user to set up, access, and modify/manage an MFA specific to that user. To this end, the financial management app may execute processes that interact with processes of MFA software resident on the MFA server 150. Alternatively, the functionality of the financial management app may be provided by one or more web pages maintained by the MFA server 150 and accessed by the electronic device 110 via a web browser application executing on the electronic device 110. For ease of explanation, however, the description corresponding to FIGS. 1, 2A, 2C, 3A, 3B, 3C, 3D, and 5 will refer to an embodiment in which a dedicated financial management app is executing on the user's electronic device.

Generally, a user may establish an MFA by accessing an MFA web site and/or downloading the financial management app, setting up credentials necessary to utilize the MFA, agreeing to terms/conditions, and paying any applicable fees. The user may choose accounts that he or she desires to be accessible via the MFA and authorize linking the selected accounts to the MFA. The MFA server 150 may establish links to the selected accounts and enable the user to view the accounts through the MFA. The user may log in to the MFA and may make manual changes, such as withdrawing funds, depositing funds, and/or transferring funds among the linked accounts. The user may also open and/or close accounts through the MFA. While logged in to the MFA, the user may receive one or more recommendations for changes to the accounts and may receive an indication of the potential benefits of implementing the recommendation(s). Also while logged in to the MFA, the user may authorize the implementation of one or more of the recommendation(s) or decline to implement any of the recommendations.

The MFA server 150 may obtain information about the linked accounts (e.g., balances, transactions, etc.), and/or provide instructions to take actions with respect to the linked accounts (e.g., make electronic payments, transfer funds, etc.), by communicating with servers 180-1 through 180-N(N being an integer greater than one, and equal to the number of institutions or organizations maintaining one or more of the linked accounts) via the network(s) 171. The servers 180-1 through 180-N may be located at facilities associated with the financial, governmental, or other institutions or organizations where the linked accounts are located. For example, the servers 180-1 through 180-N may include servers associated with banks, investment firms, mortgage companies, insurance companies, brokerages, government institutions (e.g., Social Security offices), and so on. As further examples, the servers 180-1 through 180-N may include servers associated with waste disposal companies or utilities such as electric companies, gas companies, water providers, cable companies, and/or telephone companies. Exemplary types of accounts that may be linked to the MFA may include savings accounts, checking accounts, money market funds, mutual funds, brokerage accounts, credit card accounts, mortgages, loans (e.g., car loans, home equity loans, credit union loans, etc.), utility accounts, waste removal accounts, Social Security, Medicaid, Medicare, pension plan accounts, medical accounts, and/or any other accounts that involve the movement of money or other financial assets.

The network(s) 171 may be a single communication network, or may include multiple communication networks of one or more types (e.g., one or more wired and/or wireless local area networks (LANs), and/or one or more wired and/or wireless wide area networks (WANs) such as the Internet). The network(s) 171 may include one or more networks (e.g., LANs) that is/are dedicated for communications with only one of the servers 180-1 through 180-N, as well as one or more networks (e.g., the Internet) that is/are generally used for communication with all of the servers 180-1 through 180-N. The network(s) 171 may be the same as, partially the same as, or entirely different than the network(s) 170. The different numbering and positions of the network(s) 170 and 171 in FIG. 1 are for exemplary illustrative purposes only, to clarify the communication paths (i) between the user's electronic device 110 and the MFA server 150 and (ii) between the MFA server 150 and the servers 180-1 through 180-N.

### III. Exemplary Process for Linking Accounts to a Master Financial Account

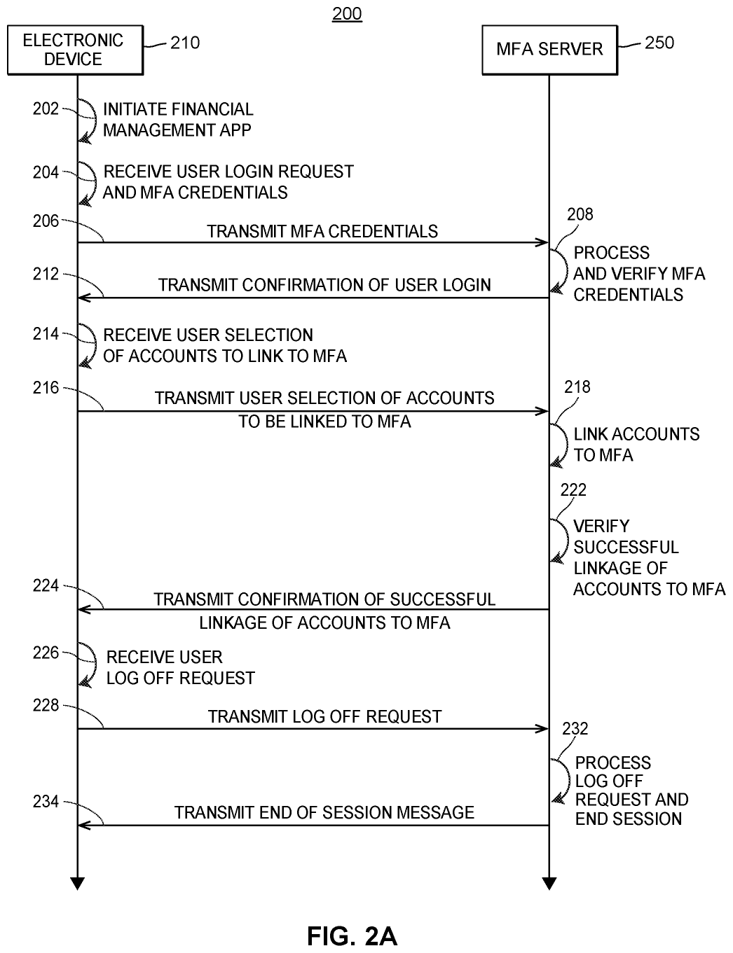

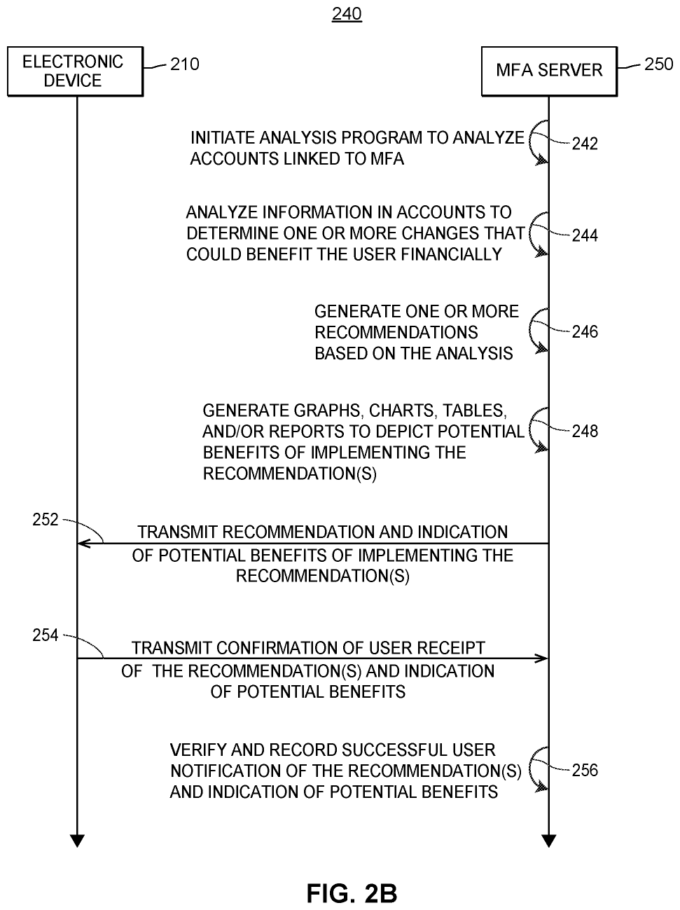

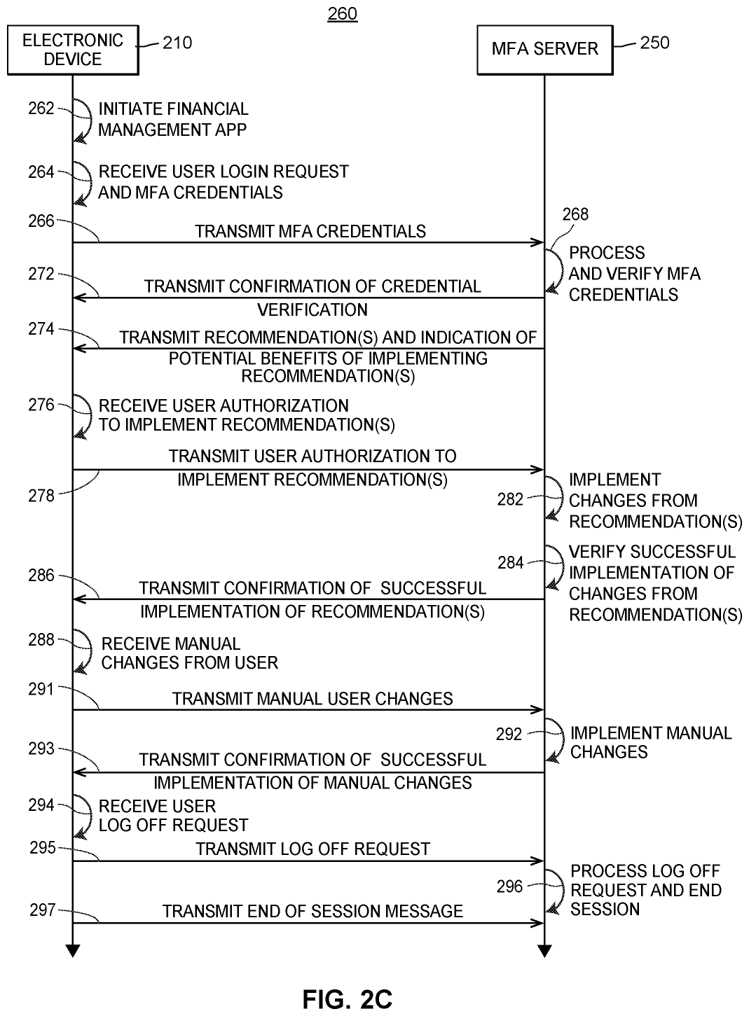

FIG. 2A is a sequence diagram depicting an example process 200 for linking accounts to the MFA, according to an embodiment. Each of FIGS. 2A-2C depicts example interactions between a user's electronic device 210 (such as the electronic device 110 of FIG. 1), and an MFA server 250 (such as the MFA server 150 of FIG. 1). In each of FIGS. 2A-2C, the actions shown on the left side may be performed by the electronic device 210 in accordance with the instructions of a financial management application (hereafter referred to as a financial management “app”) executing on the electronic device 210, and the actions shown on the right side may be performed by the MFA server 250 in accordance with the instructions of MFA software executing on the MFA server 250. It should be understood that the MFA software may execute instructions on one or more processors of the MFA server 250 to implement the tasks described herein.

Initially, a user may set up his or her own MFA by accessing an MFA web site, downloading the financial management app for installation on his or her electronic device, setting up a password and other credentials, agreeing to terms and conditions, and paying any applicable user fees. Thereafter, the user may initiate (202) the financial management app on the electronic device 210 to access his or her MFA. The electronic device 210 may then receive (204) a user login request and MFA credentials (e.g., when the user enters his or her MFA credentials via a user-interactive display provided by the financial management app), and may transmit (206) the MFA credentials to the MFA server 250. The MFA server 250 may process and verify (208) the MFA credentials (e.g., user login and password and any relevant identifying data) by comparing them to the MFA credentials stored in an MFA record specific to the user. The MFA server 250 may then transmit (212) a confirmation of user login to the MFA.

Subsequently, the electronic device 210 may receive (214) from the user a selection of accounts to link to the MFA. The selection of accounts may be accomplished by the user typing in account information, which may include account credentials needed to log in to the account and initiate and/or authorize transactions. In some embodiments, the financial management app may first provide a drop-down menu (or a searchable/browsable list, etc.) from which the user may select particular institutions that provide various types of linkable accounts. The menu or list may be populated with information sent by the MFA server 250. For each selected institution (i.e., each institution with which the user currently holds one or more accounts), the user may enter the account number(s) for each account associated with that institution. The electronic device 210 may then transmit (216) the user selection of accounts to the MFA server 250.

The MFA server 250 may link (218) the user-selected accounts to the MFA. This may include adding information indicative of the accounts (e.g., account number, institution name, etc.), and user-supplied credentials for each account, to an MFA record that is stored at the MFA server 250 and specifically associated with the user. Sensitive information in the MFA record (e.g., credentials, account numbers, etc.) may be stored in encrypted form.

The MFA server 250 may verify (222) whether links were successfully established in all of the user-selected accounts. For example, the MFA software may verify establishment of the links by executing a test transaction, such as depositing and then withdrawing a small amount of money (e.g., ten cents) to ensure that automated transactions may be successfully implemented. Once a particular account is successfully linked to the MFA, the MFA server 250 may enable the user (whenever he or she enters his or her MFA credentials) to view aspects of the account at any time, to close the account, and (if appropriate to the account type) to perform transactions such as withdrawals, deposits, and/or transfers of funds. In some embodiments, however, the MFA server 250 cannot close linked accounts, and/or cannot open new accounts (e.g., such operations must be performed by the user contacting the relevant institutions directly).

The MFA server 250 may then transmit (224) a confirmation of successful account linkage to the electronic device 210 (e.g., for display to the user). The confirmation may be presented to the user in the interactive display provided by the financial management app, for example. If any links are not successfully established, the MFA server 250 may transmit a “failure to link” message to the electronic device 210 to inform the user of the failure.

In some embodiments, the MFA server 250 may also send “failure to link” messages to help desks of the institutions involved. If the MFA server 250 receives a response from a particular help desk, the MFA server 250 may forward the response message to the electronic device 210. The user may then contact the help desk for assistance and/or resolution of the linkage failure.

After the user has completed all desired interactions in the login session, the electronic device 210 may receive (226) a log off request from the user. The electronic device 210 may then transmit (228) the log off request to the MFA server 250. The MFA server 250 may process (232) the log off request and transmit (234) the end of session message to the electronic device 210. The MFA server 250 and the electronic device 210 may then end their respective sessions.

### IV. Exemplary Process for Analyzing Accounts and Generating One or More Recommendations

FIG. 2B is a sequence diagram depicting an example process 240 for analyzing the accounts linked to the MFA, and for generating one or more recommendations and an indication of potential benefits for the user, according to an embodiment. In one embodiment, the MFA server 250 may initiate (242) an analysis program to analyze some or all of the accounts linked to the MFA. The analysis program may be initiated by the user during a user login session, or by the MFA server 250 independent of a user login session (or in response to the user logging in, etc.), for example. By executing the analysis program, the MFA server 250 may then analyze (244) information in the linked accounts to determine one or more potential changes that could benefit the user financially. The analysis may include an analysis of the current state of information associated with various linked accounts (e.g., current balances, interest rates, etc.), and/or past information associated with various linked accounts (e.g., past deposits, withdrawals, payments, etc.). The analysis may also, or instead, analyze changes or patterns/trends associated with some or all of the linked accounts. For example, the analysis may include an analysis of increases, decreases and/or more complex patterns/trends in account balances, in the dollar amounts of financial transactions (e.g., withdrawals, deposits, payments, etc.), and/or in the frequency of financial transactions. The analysis may also include a determination of changes to one or more accounts that may benefit the user, and may determine specific potential benefits to the user of implementing the changes. The analysis may also identify sources and/or destinations associated with various transactions (e.g., to determine when a deposit is associated with the user's salary/paycheck) and/or make various determinations based on the identified sources and/or destinations (e.g., to determine a category of credit card spending such as “shopping,” etc.).

Based on the analysis, the MFA server 250 may generate (246) a recommendation specifying the change(s) that were determined to be of potential benefit to the user. As one example, if the user has been depositing $200 per month in a linked savings account, and also has a linked IRA, the MFA server 250 may determine that reducing the monthly deposit in the savings account to $50, and investing the extra $150 per month in the IRA, may be beneficial to the user (e.g., allow the user to reach retirement goals a year earlier, etc.), and the MFA server 250 may recommend that the user make those changes. As another example, if a user received a raise of $200 per month, the MFA software may recommend using the raise to increase mortgage payments by $200 more each month to pay ahead on a mortgage. A third example may be to use the $200 raise to buy 10 more shares of a mutual fund each month.

In determining whether something is a financial “benefit” to the user, and/or in quantifying that benefit, the MFA server 250 may use various rules, algorithms, and/or sources of information. For example, the MFA server 250 may assume that higher dollar amounts (for savings, projected retirement funds, etc.) are more beneficial than lower dollar amounts, may utilize risk tolerances of the user (e.g., as provided by the user when the MFA was first set up), may utilize goals specified by the user (e.g., near- and long-term savings goals, desired retirement age, known future expenses, etc.), and so on. To indicate the potential benefits to the user of making the change, the MFA server 250 may generate (248) textual and/or graphical information that conveys those benefits in an easily understandable format, such as a table, chart, graph, etc.

The MFA server 250 may transmit (252) the recommendation(s) and an indication of the potential benefits of implementing the recommendation(s) to the electronic device 210. Alternatively, a notice of the recommendation(s) may be sent to the user. For example, the MFA server 250 may send a notice to the user to log in to his or her MFA to view the recommendation(s) and/or potential benefits. In either case, the transmission may be via email, text message, and/or one or more other channels. For example, the recommendation(s) and/or the indication of potential benefits may be presented to the user via a user-interactive display provided by the financial management app executing on the electronic device 210. In some embodiments, the manner in which the recommendation(s) and/or indication of potential benefits is provided to the user may depend on user preference (e.g., a selection of an option available to the user).

If the transmission to the electronic device 210 was successful, the electronic device 210 may transmit (254) a confirmation message to the MFA server 250. Successful transmission may depend on the manner in which the recommendation(s) and indication of potential benefits was sent to the user. In some embodiments, for example, the transmission cannot occur until the user has logged in to his or her MFA using the financial management app (e.g., if the app provides a display for presenting the recommendation(s) and indication of benefits). In other embodiments (e.g., where the recommendation(s) and indication of benefits is provided via email), logging in is not required.

The MFA server 250 may verify and record (256) the successful user notification of the recommendation(s) and/or the indication of potential benefits, and the analysis program may end. If the transmission was determined to be unsuccessful, then the MFA server 250 may use alternative means to contact the user using alternative user contact information such as one or more email addresses, web site(s), phone number(s), or social media contact information. After the user has been notified of the recommendation(s) and/or potential benefits via the alternative means, the analysis program may end. In some embodiments, the analysis program executes continuously (or periodically) to analyze the user's MFA, e.g., for as long as the user's MFA is still active.

### V. Exemplary Process for Authorizing and Implementing One or More Recommendations

FIG. 2C is a sequence diagram depicting an example process 260 for authorizing and implementing the recommendation(s) generated during process 240 of FIG. 2B, according to an embodiment. In response to user input, the electronic device 210 may initiate (262) a financial management app to access the MFA of the user. Alternatively, the MFA server 250 may provide one or more web pages that provide user interface functionality of the MFA, and the user may utilize a web browser on the electronic device 210 to access the MFA. The electronic device 210 may receive (264) a user login request and MFA credentials and may transmit (266) the MFA credentials to the MFA server 250. The MFA server 250 may then process and verify (268) the MFA credentials (e.g., user login and password and/or any relevant identifying data). The MFA server 250 may compare them to MFA credentials stored in the MFA record associated with that user, for example. The MFA server 250 may then transmit (272) confirmation of credential verification to the electronic device 210. In other embodiments, no express confirmation is sent, and confirmation is implied by presenting a “home screen” or other display to the user.

The electronic device 210 may transmit (274) from the MFA server 250 the recommendation(s) and indication of potential benefits of implementing the recommendation(s). The transmission (274) may correspond to the transmission (252) of FIG. 2B, or may be an additional transmission (e.g., if transmission (252) merely provided notice of the recommendation). The interactive display provided by the financial management app may prompt the user to accept (authorize) or reject the recommendation(s). The electronic device 210 may then receive (276) user authorization (e.g., authorization made by the user via a control on the interactive display provided by the financial management app) to implement the recommendation(s). The electronic device 210 may then transmit (278) the user authorization to the MFA server 250. It is understood that, in some embodiments and/or scenarios, multiple recommendations, each corresponding to one or more account changes, and their respective potential benefits, may be presented to the user, and the user may selectively authorize or not authorize particular ones of those recommendations.

The MFA server 250 may implement (282) the change(s) corresponding to the authorized recommendation(s). The MFA server 250 may communicate with servers of institutions associated with the linked accounts affected by the change(s), and may establish the authority to make the change(s) by presenting the user's credentials (stored in the MFA record) for each of those accounts. The MFA server 250 may then instruct the servers associated with those accounts to make the authorized changes, and may request confirmation of the changes from the servers associated with those accounts. It should be understood that the MFA server 250 may implement some recommendations by causing transactions to be performed on a periodic or other recurring basis. For example, the MFA server 250 may implement a recommendation of “invest an extra $200 per month in Account A” by automatically transferring $200 per month from the user's savings account to the user's “Account A” (e.g., an IRA).

After the changes are implemented, the MFA server 250 may verify (284) successful implementation of the recommended changes (e.g., by processing confirmations from the servers of the institutions involved). The MFA server 250 may then transmit (286) to the electronic device 210 a confirmation of successful implementation of the recommended changes.

In some scenarios, the electronic device 210 may also receive (288) manual account changes made by the user (e.g., changes made by the user via the interactive display provided by the financial management app) before or after the user authorizes one or more recommendations. If the electronic device 210 does receive such manual changes from the user, the electronic device 210 may transmit (291) the manual changes to the MFA server 250. The MFA server 250 may implement (292) the manual changes and may then transmit (293) to the electronic device 210 a confirmation of successful implementation of the manual changes (e.g., after performing a verification similar to verification (284)). If the user does not initiate any manual changes, or after the MFA server 250 has implemented and confirmed such changes, the electronic device 210 may wait for further instructions from the user.

The electronic device 210 may receive (294) a log off request from the user (e.g., a log off selection made by the user via the interactive display provided by the financial management app). The electronic device 210 may then transmit (295) the log off request to the MFA server 250. MFA server 250 may process (296) the log off request, transmit (297) an end of session message to the electronic device 210, and end the user's session. After receiving the end of session message, the electronic device 210 may likewise end the user's session.

### VI. Exemplary Interactive Displays for a User

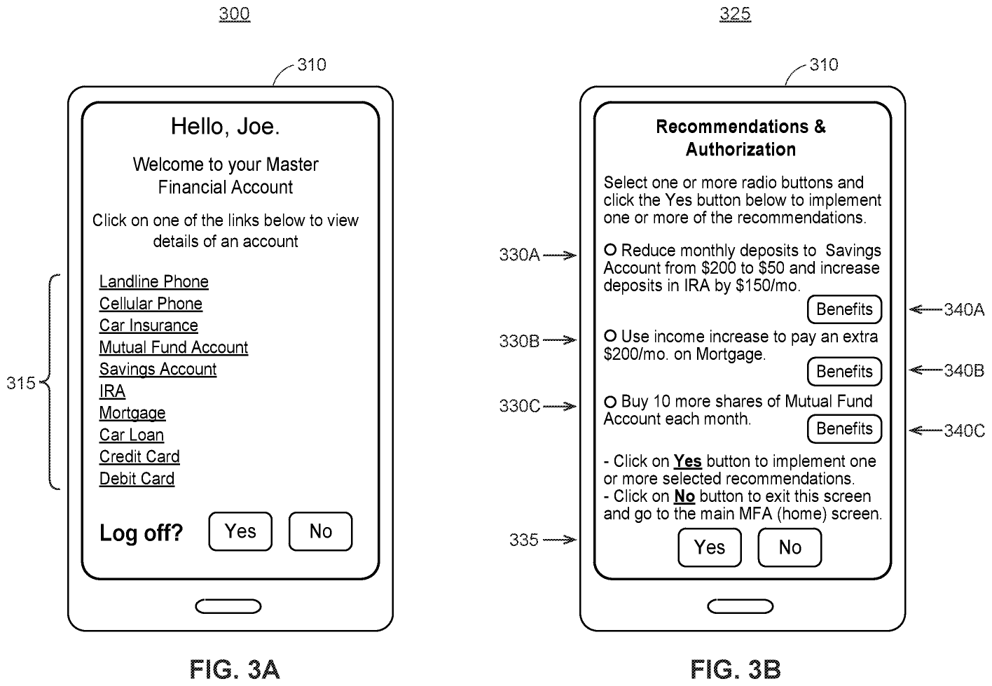

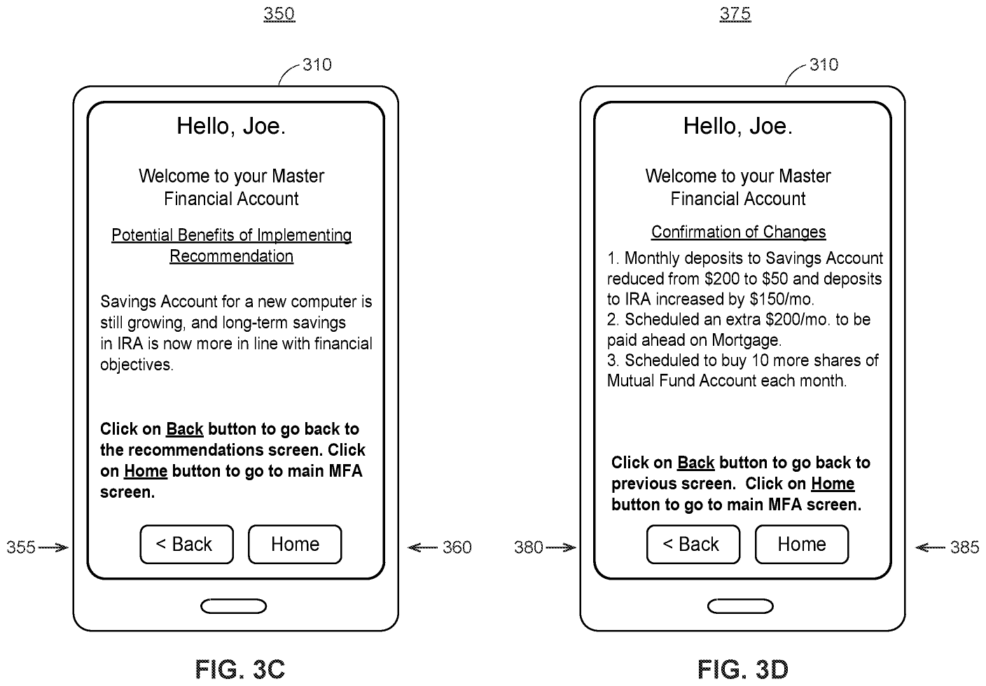

FIGS. 3A-3D depict exemplary interactive displays that may be generated and presented to the user by a financial management app executing on a user's electronic device 310 (e.g., electronic device 110 or 210, when incorporating information received from an MFA server such as MFA server 150 or 250), or by one or more web pages (e.g., web pages maintained by MFA server 150 or 250) when the electronic device 310 executes a web browser application. It is understood that the user may have additional options not reflected in FIGS. 3A-3D, and/or different options, in other screens and/or other embodiments. Referring first to FIG. 3A, an exemplary interactive display 300 presents a view of accounts 315 linked to the MFA. The accounts 315 shown in display 300 may include only those accounts that have been linked to the MFA. Each of the listed accounts 315 may be represented by a hyperlink, and the user may click on any particular hyperlink to view more information about the corresponding account (e.g., account balances, transactions, etc.). In some embodiments, clicking on a hyperlink for a particular one of accounts 315 transfers the user to a web page maintained by the institution that maintains the account. In other embodiments, the MFA server provides and/or collects the relevant account information, and provides that information to the user (e.g., via a web page maintained by the MFA server, or via a screen provided by a financial management app) without transferring the user to web pages maintained by other institutions.

Referring next to FIG. 3B, recommendations that the MFA software may generate are presented to the user via the financial management app (or a web page) in a display 325. It should be understood that the MFA software may present zero, one, or more recommendations to the user in a single login session. The recommendation(s) may include proposed changes to one or more of the plurality of accounts linked to the MFA. Further, the recommendation(s) may be in full detail, summary form, and/or simply a notice that the recommendation (or two or more recommendations) is available on a web site, and/or a link to a web site.

In the example embodiment and scenario of FIG. 3B, three recommendations are presented to the user. A first recommendation 330A suggests reducing the monthly deposit in a linked “Savings Account” and increasing the monthly deposit in a linked “IRA.” A second recommendation 330B suggests using a monthly income increase (e.g., as determined based on an increase in automatic deposits from a source known to be the user's employer) to help pay down the balance on the user's linked “Mortgage” account. A third recommendation 330C suggests buying additional shares of a mutual fund for the linked “Mutual Fund Account.”

As is also seen in the embodiment of FIG. 3B, a control 335 that enables the user to authorize or decline one or more of the recommendations may be presented with the recommendation(s) 330A-330C. Alternatively, the control 335, or a different type of request for authorization (e.g., a request that the user call to provide authorization by phone), may be presented later in that login session or in a later message to the user. In some embodiments, and in scenarios where more than one recommendation is presented to the user, the user may authorize only select ones of the recommendations. For example, the user may select (e.g., click on or touch) one or more of the radio buttons associated with recommendations 330A-330C, and then select the “Yes” button of control 335, to indicate that the selected recommendations (and only the selected recommendations) should be implemented. After the user selects the “Yes” or “No” button, the display 325 may change to the display 300, or another suitable display.

It may also be possible for the user to view more detailed information regarding the basis for the recommendation(s). For example, the display 325 may provide one or more additional controls (e.g., buttons) that the user may select to view information about which factors (e.g., a particular linked account balance reaching a threshold, a change in a particular source of income, a long-term trend in deposits to a particular linked account, etc.) influenced, prompted, and/or formed the basis for the recommendation(s).

As is also shown in FIG. 3B, the display 325 (or another display to which the user may navigate from display 325) may enable the user to view the potential benefit(s) associated with the proposed recommendations 330A-330C. In the embodiment shown, for example, user selection of controls 340A, 340B, or 340C causes the display 325 to change to a display of the potential benefits of implementing recommendation 330A, 330B, or 330C, respectively. FIG. 3C depicts an example display 350 that may be presented to the user after the user selected control 340A, according to one embodiment. Generally, the potential benefits of implementing the recommendation may be displayed in list form, in tabular form, as a graphical presentation, and/or by any other suitable means. Other examples of potential benefits may include progress towards setting up or completely funding a college tuition account, paying off a mortgage early, increasing profitability or size of investments, and so on. The user may also be able to go to a previous screen (e.g., the recommendations screen or some other screen) by clicking on a “Back” button 355. Also, the user may be able to go to the home screen by clicking on a “Home” button 360.

FIG. 3D shows an example display 375, showing the confirmation of changes that may be displayed to the user in a scenario where the user has utilized control 335, and the radio buttons associated with recommendations 330A-330C, to authorize each of recommendations 330A-330C. The display 375 may be presented to the user after the MFA server has instructed the relevant institutions to make the appropriate transactions, and after the MFA server has received confirmation of the transactions from those institutions, for example. The user may also be able to go to a previous screen by clicking on a “Back” button 380. In addition, the user may be able to go to the home screen by clicking on a “Home” button 385.

### VII. Exemplary Process Flow for Generating and Utilizing a Master Financial Account

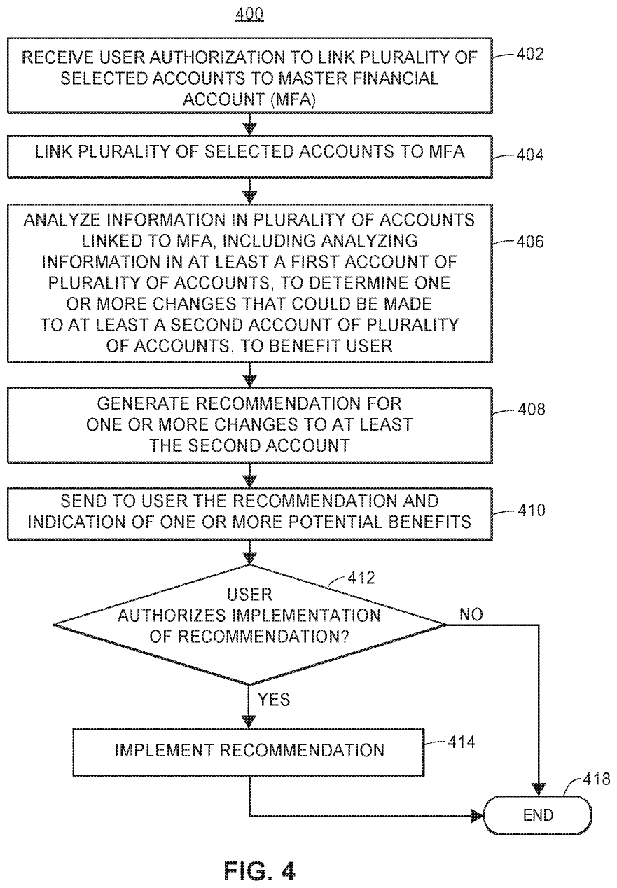

FIG. 4 is a flow diagram depicting an example method 400 for generating and utilizing an MFA, according to an embodiment. In an embodiment, the method 400 may be implemented by a server, such as MFA server 150 of FIG. 1 or MFA server 250 of FIGS. 2A-2C. For example, the method 400 may be implemented by one or more processors of such a server when executing instructions of MFA software stored in a memory (e.g., ROM or other persistent memory) of the server.

In the method 400, user authorization to link a plurality of selected accounts to an MFA of a user may be received (block 402). The user authorization may be received via one or more networks from an electronic device of the user (e.g., the electronic device 110 of FIG. 1 or the electronic device 210 of FIGS. 2A-2C), for example. In some embodiments, block 402 may include receiving user selections of accounts to be linked to the MFA. For example, after logging in to his or her MFA, the user may have been presented with a list of valid institutions (e.g., in a drop-down menu, or by browsing a list in a database stored at an MFA server, etc.), and the user may have identified the specific accounts to be linked by selecting the appropriate institution(s) and entering his or her account number(s) for each selected institution. A “valid” institution may be an institution that is known to support remote, automated access and transactions by the MFA server, for example. In some embodiments, credentials (e.g., login and password) for each account may also be received from the user. Examples of accounts that may authorized to be linked to the MFA may include bank accounts, investment accounts, government accounts, and/or other types of accounts, such as service provider accounts, utility company accounts, and/or creditor accounts (e.g., mortgage(s), loan(s), credit card(s), etc.). Examples of institutions and/or organizations whose accounts may be authorized to be linked to the MFA may include banks, investment firms, utility companies and/or other service providers, mortgage companies and/or other creditors, charitable organizations, and/or any other institutions, companies, and/or organizations with which the user may have financial transactions.

In response to receiving the authorization at block 402, the selected accounts may be linked to the MFA (block 404). Linking the selected accounts may include adding each of the selected accounts to an MFA record of the user that is maintained by the MFA server. If credentials for each selected account were also received from the user, those credentials may also be added to the user's MFA record. In some embodiments, linking an account includes communicating with a server of the institution associated with that account (e.g., to confirm that the account exists, and/or that the institution and/or account supports automated transactions with respect to the account). While not shown in FIG. 4, when the user later logs in to the MFA and provides the MFA credentials, the user may be able to view information associated with any of the linked accounts, and/or manually authorize deposits, withdrawals, and/or transfers of funds among some or all of the linked accounts. The user may also have the capability to manually authorize closing of linked accounts while logged in to the MFA, and/or manually authorize a new account to be linked to the MFA.

After the accounts have been successfully linked to the MFA, information in the plurality of accounts linked to the MFA may be analyzed to determine one or more changes that could be made to benefit the user (block 406). The analysis may include performing an analysis of information in at least a first account of the plurality of accounts to determine one or more changes that could be made to at least a second account of the plurality of accounts to benefit the user. Analyzing the information in the linked accounts may include analyzing one or more bills, savings accounts, investments, deposits, and/or any other financial transactions associated with the first account, for example. The potential benefits may be increased savings (e.g., for a children's college fund, a desired purchase, etc.), paying off a mortgage or other debt more quickly, a larger retirement savings account, or any other results that would or could financially impact the user in a positive way.

A recommendation for the one or more changes to at least the second account (i.e., the change(s) determined at block 406) may be generated (block 408). The recommendation may include one change to the second account, multiple changes to the second account, one change to each of multiple accounts (including the second account), or multiple changes to each of multiple accounts (including the second account). The recommendation may include depositing funds into the second account, withdrawing funds from the second account, transferring funds between the second account and another one or more linked accounts, and/or closing the second account, for example.

After the recommendation is generated, the recommendation, and an indication of the potential benefit(s) that could result from implementing the recommendation, may be sent to the user (block 410). The recommendation and indication of potential benefit(s) may be sent to the user at least partly in response to receiving the MFA credentials from the user (e.g., for display via a user interface provided by the financial management app, after the user has successfully logged in to the MFA). In other embodiments, the recommendation and/or indication of potential benefits is sent to the user by text message and/or email. In some embodiments, it may be verified that the user received the recommendation and indication of potential benefit(s). The indication of potential benefit(s) may include a table, chart, and/or graph that depicts the potential benefit(s), for example.

It may be determined whether an authorization to adopt the recommendation generated at block 408 is received from the user (block 412). In some embodiments, the authorization, if one exists, is received in response to sending a request to the user to authorize or decline the recommendation. The user may authorize the implementation of one or more of the recommendations by responding to a message on his or her electronic device, (e.g., by logging in to his or her MFA via a financial management app executing on the electronic device), for example, as discussed previously and exemplified in FIG. 3B.

If it is determined at block 412 that the user did not authorize implementation, the MFA session may end (block 418). If it is determined at block 412 that the user did authorize the implementation, however, the recommendation may be implemented (block 414).

Implementing the recommendation may include sending at least a portion of the credentials in the MFA record to the remote server(s) associated with each financial institution or organization maintaining the account(s) affected by the authorized recommendation(s) (i.e., at least the second account), as well as instructions to carry out the appropriate transaction(s), for example. The session may end after implementing the authorized recommendation (block 418).

In some embodiments, the method 400 may include one or more additional blocks not shown in FIG. 4. For example, the method 400 may include an additional block, between blocks 414 and 418, in which it is verified that the authorized recommendation was successfully implemented. If the authorized recommendation was not successfully implemented, a “failure to implement” message may be sent to the user and to help desk(s) of the affected account(s). The help desk(s) may send response message(s) to the user and/or to the MFA software, which may forward the messages to the user. If the authorized recommendation was implemented successfully, an implementation confirmation may be sent to the user. At some point, a log off request may be received from the user, which may end the session.

In some embodiments and scenarios, the method 400 may include receiving a manual change request from the user while the user is logged in to the MFA. For example, regardless of whether the recommendation is authorized, one or more manual change requests may be received from the user while he or she is logged in to his or her MFA, where the change requests indicate changes to be made to one or more of the linked accounts. It is understood that, in other scenarios, manual changes may be made even in the absence of any recommendations. It is also understood that, while the method 400 refers to only a single recommendation, one or more additional recommendations may also be generated at block 408 based on the analysis at block 406. In such an embodiment/scenario, the recommendations may be selectively authorized or not authorized by the user (e.g., as shown in the example embodiment and scenario of FIG. 3B).

### VIII. Exemplary Diagram for an Example Client-Side System

FIG. 5 depicts an example client-side system, by which some of the techniques described herein may be implemented, according to an embodiment. The client-side system may include an electronic device 510 (e.g., the electronic device 110 of FIG. 1 or the electronic device 210 of FIGS. 2A-2C), operated by the user.

The electronic device 510 may include a processor 519 as well as a memory 516. The memory 516 may store an operating system 514 and program data 515 capable of facilitating the functionalities as discussed herein as well as a set of applications 511 (i.e., machine readable instructions). For example, one of the set of applications 511 may be a financial management application 512 configured to interface with an MFA server that may be located at a financial institution. Alternatively, if the user can access his or her account via a web browser application stored in memory 516, the financial management application 512 may be omitted. It should be appreciated that one or more other applications 513 are envisioned, as are necessary to operate the electronic device 510.

The processor 519 may interface with the memory 516 and other components via a system bus 526 to execute the operating system 514 and the set of applications 511. In some implementations, the financial management application 512 may cause encrypted MFA credentials to be stored in the memory 516. The memory 516 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The electronic device 510 may further include a communication module 518 configured to communicate data via one or more networks 570 (e.g., one or more public and/or private networks). According to some embodiments, the communication module 518 may include one or more transceivers (e.g., WWAN, WLAN, and/or WPAN transceivers) functioning in accordance with IEEE standards, 3GPP standards, or other standards, and configured to receive and transmit data via one or more external ports 517. Further, the communication module 518 may include a short-range network component (e.g., an RFID reader) configured for short-range network communications. For example, the communication module 518 may receive location data via the network 570 or an external GPS network. For further example, the communication module 518 may transmit data to, and receive data from, the MFA server via the network 570. The electronic device 510 may further include a removable non-volatile memory interface 521. In addition, the electronic device 510 may include a storage device 522, such as a hard drive or SSD.

The electronic device 510 may further include a user interface 523 configured to present information to a user and/or receive inputs from the user. As shown in FIG. 5, the user interface 523 may include a display screen 524 and I/O components 525 (e.g., ports, capacitive or resistive touch sensitive input panels, keys, buttons, lights, LEDs, speakers, microphones). According to some embodiments, the user may access the electronic device 510 via the user interface 523 to make various selections, log in to any of the set of applications 511, and/or perform other functions. In some embodiments, the electronic device 510 may perform the functionalities as discussed herein as part of a “cloud” network or may otherwise communicate with other hardware or software components within the cloud to send, retrieve, or otherwise analyze data.

In general, a computer program product in accordance with an embodiment may include a computer usable storage medium (e.g., standard random access memory (RAM), an optical disc, a universal serial bus (USB) drive, or the like) having computer-readable program code embodied therein, wherein the computer-readable program code may be adapted to be executed by the processor 519 (e.g., working in connection with the operating system 514) to facilitate the functions as described herein. In this regard, the program code may be implemented in any desired language, and may be implemented as machine code, assembly code, byte code, interpretable source code or the like (e.g., via C, C++, Java, Actionscript, Objective-C, JavaScript, CSS, XML). In some embodiments, the computer program product may be part of a cloud network of resources. The electronic device may include additional, less, or alternate components and functionality, including that discussed elsewhere herein.

### IX. Exemplary Diagram for Back-End Computer System

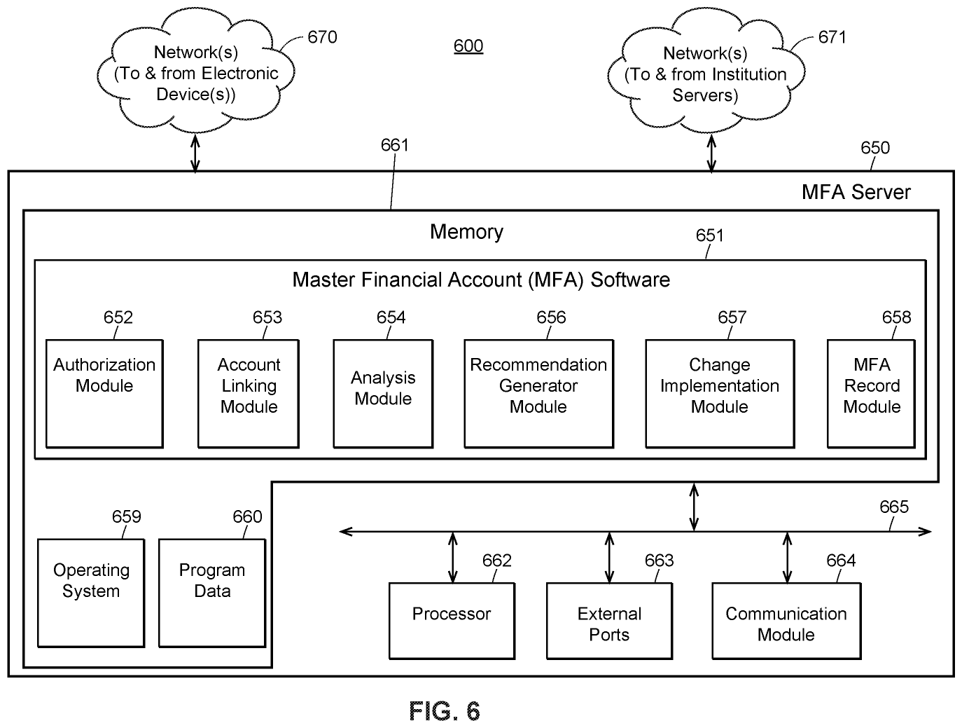

FIG. 6 depicts an example back-end computer system, by which some of the techniques described herein may be implemented, according to an embodiment. The back-end computer system 600 may include an MFA server 650 (e.g., the MFA server 150 of FIG. 1 or the MFA server 250 of FIGS. 2A-2C). In some embodiments, the method 400 of FIG. 4 is implemented by the MFA server 650.

The MFA server 650 of FIG. 6 may include, but is not limited to, the following components: a system memory 661, a processor 662, external ports 663, and a communication module 664. The MFA server 650 may also include a system bus 665 that couples various system components, including the system memory 661, to the processor 662. The system bus 665 may be any of several types of bus structures including a memory bus or memory controller, a peripheral bus, or a local bus, and may use any suitable bus architecture. By way of example, and not limitation, such architectures may include the Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

The MFA server 650 may include a variety of computer-readable media. Computer-readable media can be any available media that can be accessed by the processor 662 and includes both volatile and nonvolatile media, and both removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the processor 662. Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of any of the above are also included within the scope of computer-readable media.

By way of example, and not limitation, FIG. 6 also illustrates a memory 661 including, but not limited to, MFA software 651, an operating system 659, and program data 660. The MFA software 651 may provide access to accounts through the MFA and may oversee financial transactions authorized and/or requested by the user, as described elsewhere herein. The MFA software 651 may also receive authorization from the user to link selected accounts. The MFA software 651 may cause credentials such as encrypted login and password data for one or more of the plurality of the linked accounts to be stored in a MFA record module 658. Also, the MFA software 651 may establish the links to the selected accounts and communicate with the institutions/servers maintaining the accounts to enable the user to view the accounts.

The MFA software 651 may include an authorization module 652, an account linking module 653, an analysis module 654, a recommendation generator module 656, a change implementation module 657, and an MFA record module 658. Generally, and as described in more detail above, the authorization module 652 may request and/or receive authorization from the user to link selected accounts to the MFA, the account linking module 653 may link accounts to the MFA that were selected by the user (e.g., so that the accounts may be accessed by the MFA software to allow the user to view linked accounts and make manual changes or authorize recommended changes to the accounts), and the analysis module 654 may provide the analysis function to analyze the accounts (e.g., analyze balances and/or changes such as increases and/or decreases and/or trends in accounts) to determine potential financial benefits to the user. The recommendation generator module 656 may generate one or more recommendations, based on the analysis performed by the analysis module 654. The recommendation(s) may suggest changes to one or more accounts that may include deposits, withdrawals, transfers of funds, opening new accounts, closing accounts, etc., as discussed in more detail above. In addition to receiving authorization from the user to link accounts as described above, the authorization module 652 may also provide a request to the user to authorize one or more recommendations, and the authorization module 652 may receive authorization from the user to implement one or more recommendations. The change implementation module 657 may implement the changes included in the authorized recommendation(s). The change implementation module 657 may also check for successful implementation of the changes and may provide confirmation messages to the MFA software and/or to the user. The MFA record module 658 may store credentials for accessing the MFA and/or for accessing each of the plurality of accounts linked to the MFA.

The MFA server 650 may further include a communication module 664 configured to communicate data via one or more networks 670 and/or 671. According to some embodiments, the communication module 664 may include one or more transceivers (e.g., WWAN, WLAN, and/or WPAN transceivers) functioning in accordance with IEEE standards, 3GPP standards, or other standards, and configured to receive and transmit data via one or more external ports 663. For example, the communication module 664 may transmit and/or receive, via the network(s) 670, data to and/or from the electronic device(s). Additionally, the communication module 664 may transmit and/or receive, via the network(s) 671, data to and/or from the various financial institutions and/or organizations maintaining the accounts that are linked (or will be linked). The network(s) 670 and 671 may be a single communication network, or may include multiple communication networks of one or more types (e.g., one or more wired and/or wireless local area networks (LANs), and/or one or more wired and/or wireless wide area networks (WANs) such as the Internet). The network(s) 671 may be the same or different network(s) as the network(s) 670.

In general, a computer program product in accordance with an embodiment may include a computer usable storage medium (e.g., standard random access memory (RAM), an optical disc, a universal serial bus (USB) drive, or the like) having computer-readable program code embodied therein, wherein the computer-readable program code may be adapted to be executed by the processor 662 (e.g., working in connection with the operating system 659) to facilitate the functions as described herein. In this regard, the program code may be implemented in any desired language, and/or may be implemented as machine code, assembly code, byte code, interpretable source code or the like (e.g., via C, C++, Java, Actionscript, Objective-C, Javascript, CSS, XML). In some embodiments, the computer program product may be part of a cloud network of resources. The MFA server 650 may include additional, less, or alternate functionality, including that discussed elsewhere herein.

### X. Additional Considerations

The following additional considerations apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process of creating and utilizing an MFA through the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

1. A computer-implemented method for providing a master financial account for a user, comprising:
receiving, by one or more processors and from the user, authorization to link a plurality of accounts of the user to the master financial account, at least some of the plurality of accounts being associated with different financial institutions;
in response to receiving the authorization, linking, by one or more processors, the plurality of accounts to the master financial account, wherein linking the plurality of accounts to the master financial account includes adding each of the plurality of accounts to a master financial account record;
analyzing, by one or more processors, information in the plurality of accounts that are linked to the master financial account to determine changes that could be made to benefit the user, wherein analyzing the information in the plurality of accounts includes (i) determining, by monitoring a first account of the plurality of accounts over a period of time, that an increase in income is persistent, and (ii) analyzing the information in the plurality of accounts to determine changes that could be made to at least the first account, a second account of the plurality of accounts, and a third account of the plurality of accounts to benefit the user;
generating, by one or more processors, a recommendation indicating the changes;
causing, by one or more processors, a graphical user interface presented by an electronic device of the user to display (i) the recommendation indicating the changes, and (ii) an interactive authorization control that triggers the changes, at least by transmitting the recommendation to the electronic device;
receiving, by one or more processors and from the electronic device, an indication that the user activated the interactive authorization control presented by the graphical user interface; and
in response to receiving the indication, implementing, by one or more processors, the changes.

2. The computer-implemented method of claim 1, wherein receiving authorization to link the plurality of accounts to the master financial account includes receiving user selections of accounts to be linked to the master financial account.

3. The computer-implemented method of claim 1, wherein receiving authorization to link the plurality of accounts to the master financial account includes receiving authorization to link two or more of (i) a bank account, (ii) an investment account, or (iii) a government account, to the master financial account.

4. The computer-implemented method of claim 1, wherein receiving authorization to link the plurality of accounts to the master financial account includes receiving authorization to link two or more of (i) a service provider account, (ii) a utility company account, (iii) a mortgage account, or (iv) a creditor account, to the master financial account.

5. The computer-implemented method of claim 1, further comprising receiving from the user credentials associated with the plurality of accounts, wherein adding each of the plurality of accounts to the master financial account record includes adding the credentials associated with the plurality of accounts to the master financial account record.

6. The computer-implemented method of claim 5, wherein implementing the one or more changes includes sending at least a portion of the credentials in the master financial account record to a remote server associated with a financial institution maintaining the second account.

7. The computer-implemented method of claim 1, wherein analyzing the information in the plurality of accounts linked to the master financial account includes analyzing one or more of (i) one or more bills associated with the first account, (ii) one or more savings account balances associated with the first account, (iii) one or more investments associated with the first account, or (iv) one or more deposits to the first account.

8. (canceled)

9. The computer-implemented method of claim 21, wherein the indication of the one or more potential benefits includes one or more of (i) a table, (ii) a chart, or (iii) a graph, that depicts the one or more potential benefits of following the recommendation.

10.-11. (canceled)

12. The computer-implemented method of claim 1, further comprising:
receiving master financial account credentials from the user via a financial management application executing on an electronic device of the user; and
at least partly in response to receiving the master financial account credentials from the user, enabling the user to do one or more of
(i) view information associated with one or more of the plurality of accounts linked to the master financial account,
(ii) manually transfer funds or authorize transactions in one or more of the plurality of accounts linked to the master financial account,
(iii) close one or more of the plurality of accounts linked to the master financial account, or
(iv) authorize a new account to be linked to the master financial account.

13. The computer-implemented method of claim 1, further comprising:
receiving master financial account credentials from the user via a financial management application executing on an electronic device of the user,
wherein transmitting the recommendation is at least partly in response to receiving the master financial account credentials.

14. A tangible, non-transitory computer-readable medium storing instructions that, when executed by one or more processors, cause the one or more processors to:
receive, from a user, authorization to link a plurality of accounts of the user to a master financial account, at least some of the plurality of accounts being associated with different financial institutions;
in response to receiving the authorization, link the plurality of accounts to the master financial account, at least in part by adding each of the plurality of accounts to a master financial account record;
analyze information in the plurality of accounts that are linked to the master financial account to determine changes that could be made to benefit the user, at least in part by (i) determining, by monitoring a first account of the plurality of accounts over a period of time, that an increase in income is persistent, and (ii) analyzing the information in the plurality of accounts to determine changes that could be made to at least the first account, a second account of the plurality of accounts, and a third account of the plurality of accounts to benefit the user;
generate a recommendation indicating the changes;
cause a graphical user interface presented by an electronic device of the user to display (i) the recommendation indicating the changes, and (ii) an interactive authorization control that triggers the changes, at least by transmitting the recommendation to the electronic device;
receive, from the electronic device, an indication that the user activated the interactive authorization control presented by the graphical user interface; and
in response to receiving the indication, implement the changes.

15. The tangible, non-transitory computer-readable medium of claim 14, wherein the instructions cause the one or more processors to:
receive authorization to link the plurality of accounts to the master financial account; and
receive authorization to link two or more of (i) a bank account, (ii) an investment account, or (iii) a government account, to the master financial account.

16. The tangible, non-transitory computer-readable medium of claim 14, wherein the instructions cause the one or more processors to:
receive authorization to link the plurality of accounts to the master financial account; and
receive authorization to link two or more of (i) a service provider account, (ii) a utility company account, (iii) a mortgage account, or (iv) a creditor account, to the master financial account.

17. The tangible, non-transitory computer-readable medium of claim 14, wherein the instructions cause the one or more processors to:
analyze the information in the plurality of accounts linked to the master financial account; and
analyze one or more of (i) one or more bills associated with the first account, (ii) one or more savings account balances associated with the first account, (iii) one or more investments associated with the first account, or (iv) one or more deposits to the first account.

18. (canceled)

19. A server, comprising:
one or more processors;
a communication module configured to transmit and receive data via one or more networks; and
a non-transitory memory storing instructions that, when executed by the one or more processors, cause the one or more processors to:
receive, from a user, authorization to link a plurality of accounts of the user to a master financial account, at least some of the plurality of accounts being associated with different financial institutions;
in response to receiving the authorization, link the plurality of accounts to the master financial account, at least in part by adding each of the plurality of accounts to a master financial account record;
analyze information in the plurality of accounts that are linked to the master financial account to determine changes that could be made to benefit the user, at least in part by (i) determining, by monitoring a first account of the plurality of accounts over a period of time, that an increase in income is persistent, and (ii) analyzing the information in the plurality of accounts to determine changes that could be made to at least the first account, a second account of the plurality of accounts, and a third account of the plurality of accounts to benefit the user;
generate a recommendation indicating the changes;
cause a graphical user interface presented by an electronic device of the user to display (i) the recommendation indicating the changes, and (ii) an interactive authorization control that triggers the changes, at least by transmitting the recommendation to the electronic device;
receive, from the electronic device, an indication that the user activated the interactive authorization control presented by the graphical user interface; and
in response to receiving the indication, implement the changes.

20. The server of claim 19, wherein the instructions cause the one or more processors to implement the changes at least in part by sending credentials in the master financial account record to a remote server associated with a financial institution maintaining the second account.

21. The computer-implemented method of claim 1, further comprising:
causing, by one or more processors, the graphical user interface presented by the electronic device of the user to display an indication of one or more potential benefits of making the changes, at least by transmitting the indication to the electronic device.

22. The tangible, non-transitory computer-readable medium of claim 14, wherein the instructions further cause the one or more processors to:
cause the graphical user interface presented by the electronic device of the user to display an indication of one or more potential benefits of making the changes, at least by transmitting the indication to the electronic device.

23. The server of claim 19, wherein the instructions further cause the one or more processors to:
cause the graphical user interface presented by the electronic device of the user to display an indication of one or more potential benefits of making the changes, at least by transmitting the indication to the electronic device.
